(19) United States
(12) Patent Application Publication
(10) Pub. No.: US 2024/0341392 A1
(43) Pub. Date: Oct. 17, 2024

(54) DETACHABLE HARNESS SYSTEM

(71) Applicant: Tomasz B. Mironski, Cameron, NC (US)

(72) Inventor: Tomasz B. Mironski, Cameron, NC (US)

(21) Appl. No.: 18/429,683

(22) Filed: Feb. 1, 2024

Related U.S. Application Data
(60) Provisional application No. 63/459,023, filed on Apr. 13, 2023.

(51) Int. Cl. A42B 3/08; A42B 3/04; A62B 35/00

(52) U.S. Cl. CPC A42B 3/085; A42B 3/042; A62B 35/0025

(57) ABSTRACT

A detachable harness system includes a base plate and a first fastening member disposed at the base plate. The first fastening member may engage with a second fastening member of a first accessory. The first fastening member may include a female end of a fastener assembly, and the second fastening member may include a male end of the fastener assembly. The first accessory may be a helmet.

### CROSS-REFERENCE TO RELATED APPLICATION

This application claims the benefit of priority of U.S. provisional application No. 63/459,023, filed Apr. 13, 2023, the contents of which are herein incorporated by reference.

### BACKGROUND OF THE INVENTION

### Field of the Invention

The present invention relates to a harness system, and more particularly to a detachable harness system.

### Description of the Related Art

A harness system such as a skullcrusher is typically used to navigate obstacles with ease. Skullcrushers are configured to be removably attached to accessories such as night vision devices that assist the user in night hunting, moving around at night time, etc.

Conventional skullcrushers require long and complicated attachment and detachment process to removably attach/detach devices/accessories to the skullcrushers, which may cause inconvenience to users.

Thus, there exists a need for a harness system that eases the process of attachment/detachment with additional devices.

### SUMMARY OF THE INVENTION

The following presents a simplified summary of the present disclosure in a simplified form as a prelude to the more detailed description that is presented herein.

In accordance with embodiments of the invention, there is provided a detachable harness system. The system may include a base plate and a first fastening member. The first fastening member may be disposed on the base plate. The first fastening member may be configured to engage with a second fastening member of a first accessory. The first fastening member may include a female end of a fastener assembly, and the second fastening member may include a male end of the fastener assembly. In some aspects, the first accessory may be a helmet.

In some aspects, the base plate may be disposed at a front portion of the detachable harness system. The second fastening member may include a screw, and the first fastening member may include a cavity.

In some aspects, the base plate further may include a hook and loop fastener at a front portion of the detachable harness system, and the hook and loop fastener may be configured to engage the detachable harness system with a second accessory. The second accessory may include a night vision system. In some aspects, the hook and loop fastener may be disposed at the base plate. The detachable harness system may further include a plurality of cushion pads disposed at a top portion of the detachable harness system.

The present disclosure discloses a detachable harness system that may be removably attached to accessories or devices (such as a helmet). The detachable harness system may be lightweight and padded. The detachable harness system may be configured to attach and detach with the accessories or devices, using simple attachment/detachment assembly. Thus, the detachable harness system may be configured to attach quickly and conveniently with/detach from the accessories or devices. In this manner, the detachable harness system offers an efficient way to attach/detach the accessories or devices, without replacing, unscrewing, attaching, detaching the padded inserts, chin straps, etc. In addition, the detachable harness system can be used as a standalone device, and may be mounted with helmet, night vision systems, etc., if required.

The detachable harness system is suitable for heavier, ballistic-impact-resistant materials, which permit adjustment of the helmet's center of gravity relative to the wearer. The system provides increased stability and retention of the helmet on the head and minimizes pressure points on the head. The system further accommodates a range of head sizes, and allows easy and fast servicing or replacement of components.

The detachable harness system may include a thin, stiff plastic-type headband arranged within, but free of and spaced from the interior of a helmet shell and secured thereto by means of integral, stiff tabs secured to a flexible band located above the headband. The flexible band may in turn be secured to the shell, and with the flexible band and the headband being further interconnected by a pair of side restraining or motion limiting straps, the combination thereby provides a secure mounting of the helmet upon the wearer's head and permits a limited amount of helmet motion relative to the head.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which:

FIG. 1 depicts a front perspective view of a detachable harness system in accordance with the present disclosure.

FIG. 2 depicts an exploded view of a helmet embodiment in accordance with the present disclosure.

FIG. 3 depicts a cross-sectional view of a quick detach assembly in a first position in accordance with the present disclosure.

FIG. 4 depicts a cross-sectional view of a quick detach assembly in a second position in accordance with the present disclosure.

FIG. 5 depicts a cross-sectional exploded view of a quick detach assembly in accordance with the present disclosure.

FIG. 6 depicts a perspective view of the detachable harness system with a first accessory in accordance with the present disclosure.

FIG. 7 depicts a perspective view of the detachable harness system with a second accessory in accordance with the present disclosure.

### DETAILED DESCRIPTION OF INVENTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

Reference will now be made in detail to the present preferred embodiments of the invention, examples of which are illustrated in the accompanying drawings. Wherever possible, the same reference numerals are used in the drawings and the description to refer to the same or like parts.

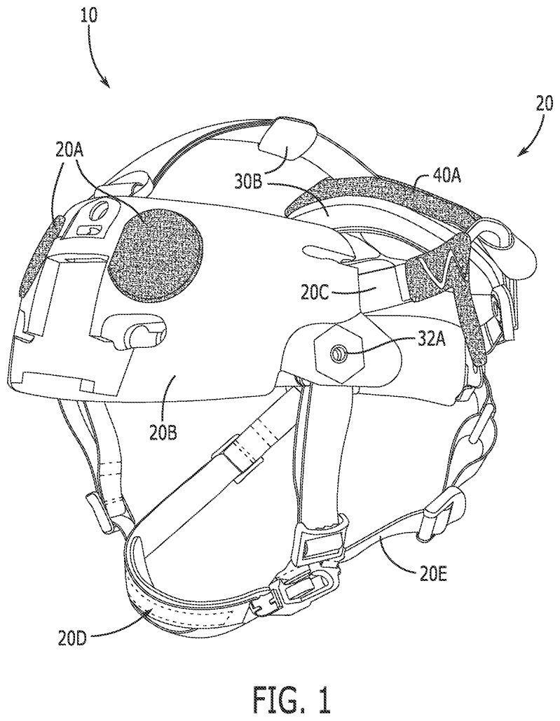

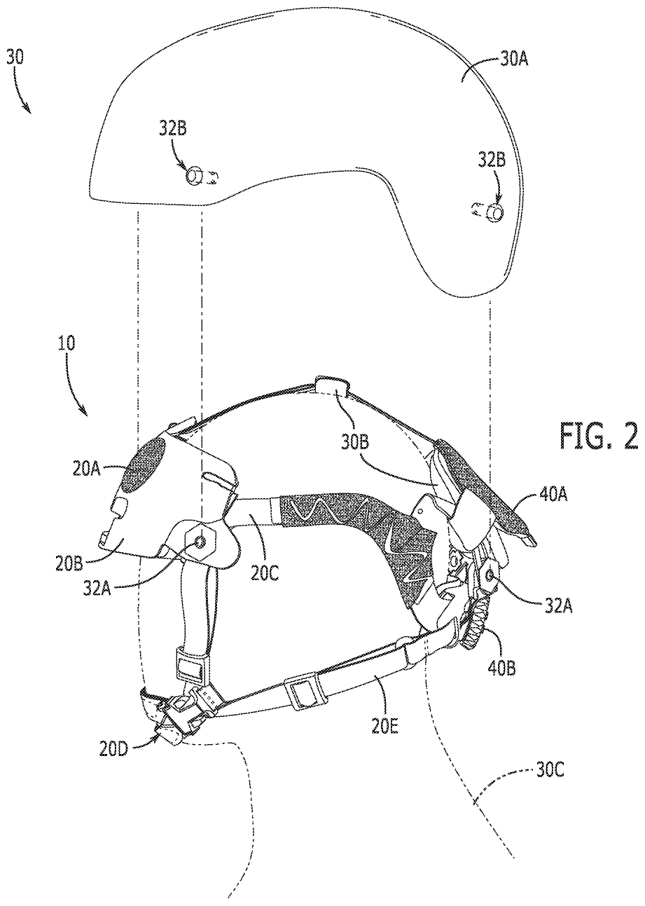

FIG. 1 depicts a front perspective view of a detachable harness system 10 in accordance with the present disclosure. Specifically, FIG. 1 describes a standalone embodiment 20 of the detachable harness system 10. While describing FIG. 1, references will be made to FIG. 2.

In some aspects, the detachable harness system 10 is configured to be removably attached to different accessories (e.g., night vision accessories) and devices (such as helmet 30A). The detachable harness system 10 may include a front portion and a rear portion (or back portion), which may be made of any material and may have specific shape that mimics a head of a user 30C. The detachable harness system 10 may include a plurality of cushion pads (as described below) that may minimize pressure and weight points on the user's head, and prevent discomfort to the user 30C. The detachable harness system 10 may be made up of a single material, any mixture of materials, or any combination thereof. The materials may be any natural (raw) materials or man-made (synthetic) materials.

The detachable harness system 10 may include a plurality of components including, but not limited to, a fastening mechanism 20A, a base plate 20B, a flexible headband 20C, a chin strap 20D, and a webbing 20E. The plurality of components provides support in all the directions and facilitates the user 30C to wear the detachable harness system 10 properly (without any movement). The details of the plurality of components are provided below.

The fastening mechanism 20A may be a fastener that may be configured to removably attach the detachable harness system 10 to other accessories or devices (like the helmet 30A). In some aspects, the fastening mechanism 20A may be a hook and loop fastener, which may be located on the base plate 20B. Specifically, the fastening mechanism 20A may be located at a top portion of the base plate 20B. In some aspects, the base plate 20B may include a plurality of hook and loop fasteners, which may be disposed at a predetermined distance from each other to properly secure the other accessories or devices. In some aspects, the hook and loop fastener may be of any shape and size, which may enable secure connection between the detachable harness system 10 and the other accessories or devices.

The base plate 20B may be a plate that may be disposed at the front top portion of the detachable harness system 10, and may be configured to cover a portion of a user forehead, when worn by the user 30C. The base plate 20B may be made of any material. For example, the base plate 20B may be made of plastic. In other aspects, the base plate 20B may be made of fabric or any other material.

The flexible headband 20C may be a headband that may be attached to two opposite ends of the base plate 20B. The flexible headband 20C may be located in a side portion (and/or the back portion) of the detachable harness system 10, and may be configured to provide side support and back support. In some aspects, the flexible headband 20C may connect the front portion to the back portion. The headband 20C may be flexible and may enable users of different head sizes to wear the detachable harness system 10 comfortably. In some aspects, the flexible headband 20C may be made of any material that enables flexibility of the headband. In further aspects, the flexible headband 20C may include fastening mechanism that may facilitate attachment of the detachable harness system 10 with the other accessories/devices. In some aspects, the fastening mechanism may cover a portion (including complete portion) of the flexible headband 20C.

The chin strap 20D may be configured to support chip portion of the user 30C. The chip strap may be made of any material. In some aspects, the chin strap 20D may include a cushion pad that may be attached at an interior surface of the chin strap 20D. The webbing 20E may be connected between the chin strap 20D and the flexible headband 20C (and/or between the chin strap 20D and the base plate 20B), and may be configured to enable the user 30C to perform length adjustment to secure the detachable harness system 10 on the user's head. The webbing 20E may be disposed on both the sides. The webbing 20E may be made of any material, such as nylon.

The detachable harness system 10 may further include a cushion pad 30B that may be located at the top portion of the detachable harness system 10, which provides cushion to the user's head when the helmet 30A may be attached to the detachable harness system 10 from a top portion of the detachable harness system 10. In some aspects, the cushion pad 30B may be located at a portion of a belt (located at the top portion). In some aspects, the belt may include a plurality of cushion pads which may be disposed at a predetermined distance from each other. In further aspects, the detachable harness system 10 may include the cushion pad at the back portion of the detachable harness system 10 to provide cushion when other accessories or devices are attached at the back portion of the detachable harness system 10.

The detachable harness system 10 may further include a quick detach (QD) mechanism assembly 32 that may be configured to quickly attach or detach the device, such as the helmet 30A, to the detachable harness system 10. In some aspects, the detachable harness system 10 may include a female end 32A of the quick detach mechanism assembly 32. The female end 32A of the quick detach mechanism assembly 32 may be configured to engage with a male end 32B of the quick detach mechanism assembly 32. The male end 32B of the quick detach mechanism assembly may be located at the helmet 30A (as shown in the helmet embodiment 30 of FIG. 2). In some aspects, the quick detach mechanism assembly 32 may include four Quick Detachment (QD) screws, four male washers, and eight female washers. Specifically, the male end 32B may include QD screws and the female end 32A may include cavities. The QD screws may be equipped with a spring mechanism that allows the detachable harness system 10 to separate/detach from the helmet 30A (e.g., by pressing the head of the screws and pulling the detachable harness system 10 from the helmet 30A). The detachable harness system 10 may be attached to the helmet 30A by pushing the connection points towards the screws of the helmet 30A.

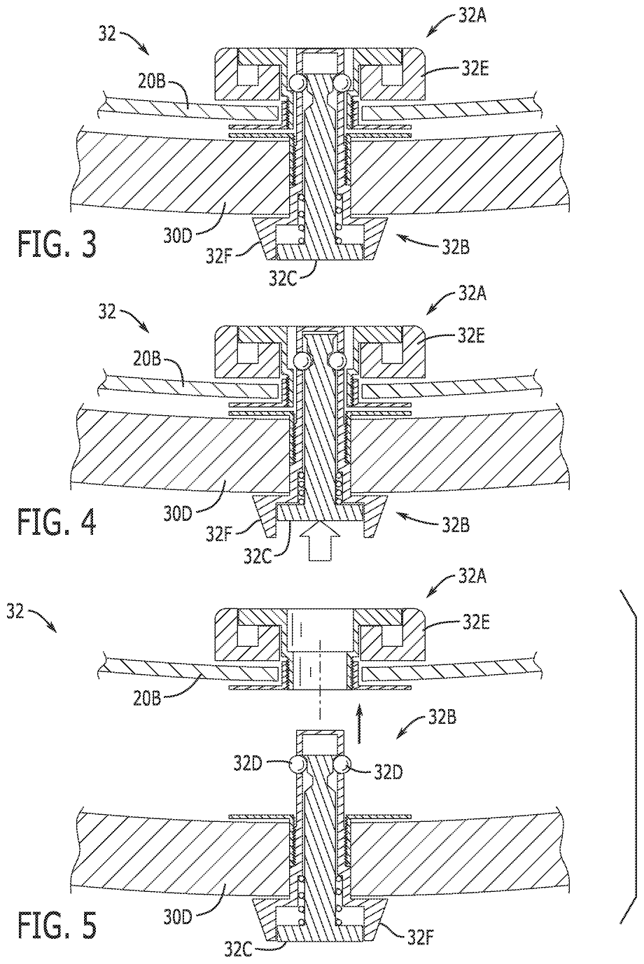

In some aspects, the detachable harness system 10 may include four female ends 32A of the quick detach mechanism assembly, and the helmet 30A may include corresponding four male ends 32B of the quick detach mechanism assembly. The four male ends 32B of the quick detach mechanism assembly may be disposed in alignment with the four female ends 32A of the quick detach mechanism assembly. The quick detach mechanism assembly facilitates easy connection/attachment of the detachable harness system 10 and the helmet 30A, and further facilitates easy detachment of the detachable harness system 10 and the helmet 30A. Further details of the engagement between the female ends 32A and the male ends 32B may be understood in conjunction with FIGS. 3-5.

In some aspects, the two female ends 32A may be located at the front portion of the detachable harness system 10. For example, the two female ends may be disposed on the two opposite ends of the base plate 20B. Alternatively, the female ends may be disposed in proximity to the opposite ends of the base plate 20B (and not disposed on the base plate 20B). The other two female ends may be located at the back portion of the detachable harness system 10. The detachable harness system 10 may include more or less number of the female ends to facilitate secure attachment between the detachable harness system 10 and the helmet 30A.

In operation, the user 30C may use the detachable harness system 10 in the standalone mode (e.g., the standalone embodiment 20) when the user 30C does not desire to use the helmet 30A. When the user 30C desires to use the helmet 30A (e.g., in the helmet embodiment 30), the user 30C may simply engage the female ends 32A with the male ends 32B. This way, the user 30C may easily and conveniently attach the detachable harness system 10 and the helmet 30A. When the user 30C again desires to use the standalone embodiment 20, the user 30C may simply disengage the female ends 32A from the male ends 32B, and remove the helmet 30A.

The detachable harness system 10 may further include fastening mechanism 40A that may be disposed at the back portion (or any other portion) of the detachable harness system 10. The fastening mechanism 40A may be a hook and loop fastener that may be configured to allow attachment of other accessories to the detachable harness system 10. In some aspects, the fastening mechanism 40A may be disposed at a part of the back portion. In further aspects, the detachable harness system 10 may include a plurality of hook and loop fasteners that may be disposed at a predetermined distance from each other to facilitate proper connection between the detachable harness system 10 and the accessories.

The detachable harness system 10 may further include an adjustable knob 40B that may be configured to adjust the length of the webbing 20E. For example, the user 30C may turn the knob 40B in a first direction (e.g., clockwise or anticlockwise direction) to increase the length of the webbing 20E and may turn the knob 40B in a second direction (opposite to the first direction) to decrease the length of the webbing 20E.

FIGS. 3-5 depict the engagement between the female ends 32A and the male ends 32B to attach the detachable harness system 10 with the helmet 30A. Specifically, FIG. 3 depicts a cross-sectional view of a quick detach assembly in a first position. FIG. 4 depicts a cross-sectional view of a quick detach assembly in a second position (e.g., a released position), and FIG. 5 depicts a cross-sectional exploded view of the quick detach assembly. The details of FIGS. 3-5 may be understood as follows.

The helmet 30A may include a helmet wall 30D. The helmet wall 30D may include a body of a quick detach bolt 32F (part of the male end 32B), that may pass through the helmet wall 30D. In an exemplary aspect, the helmet wall 30D may include a through-hole/opening that may be configured to receive the body of a quick detach bolt 32F. In some aspects, the body of a quick detach bolt 32F may be integrated to the helmet wall 30D. The body of a quick detach bolt 32F may be configured to receive/hold a push button 32C (or head of QD screw). The push button 32C may be configured to slide up and down in the body of a quick detach bolt 32F to engage or disengage with the female end 32A, via ball bearings 32D. The ball bearings 32D may be configured to move in a first position (as shown in FIG. 3) and a second position (as shown in FIG. 4) to engage/disengage the helmet 30A with the detachable harness system 10. In the first position, the ball bearings 32D may lock the helmet 30A with the detachable harness system 10, and in the second position, the ball bearings 32D may unlock the helmet 30A from the detachable harness system 10 (to allow detachment of the helmet 30A and the detachable harness system 10).

In some aspects, the push button 32C may be a T-shaped button having a vertical portion and a horizontal portion (head portion). A part of the vertical portion may be configured to move inside the female end 32A to engage the helmet 30A and the detachable harness system 10. In further aspects, the vertical portion may include a neck portion that may be configured to receive ball bearings 32D (e.g., in the second position) to disengage the helmet 30A from the detachable harness system 10.

In some aspects, the female end 32A may be disposed on the base plate 20B. In some aspects, the base plate 20B may include an opening that may be configured to receive helmet strap buckles 32E (part of the female end 32A). The helmet strap buckles 32E may be configured to receive and lock the push button 32C to engage/disengage the helmet 30A. In some aspects, the helmet strap buckles 32E may be integrated to the base plate 20B.

In operation, when the user 30C desires to attach the helmet 30A to the detachable harness system 10, the user 30C may insert the push button 32C in the helmet strap buckles 32E (as depicted in FIG. 3). When the push button 32C is inserted in the helmet strap buckles 32E, the helmet 30A is locked to the detachable harness system 10. For example, when the push button 32C is inserted in the helmet strap buckles 32E, the ball bearings 32D move to the first position in which the ball bearings 32D prevent the push button 32C to come out of the helmet strap buckles 32E. When the user 30C desires to detach the helmet 30A from the detachable harness system 10, the user 30C may press the push button 32C (disposed inside the body of a quick detach bolt 32F), as shown in FIG. 4. When the user presses the push button 32C, the ball bearings 32D may move over the neck portion (i.e., in the second position) and may allow the user 30C to detach the helmet 30A from the detachable harness system 10 (by keeping the push button 32C in the pushed position). For example, the user 30C may keep the push button 32C in the pushed position, and pull the helmet 30A against the detachable harness system 10 to take the helmet 30A out.

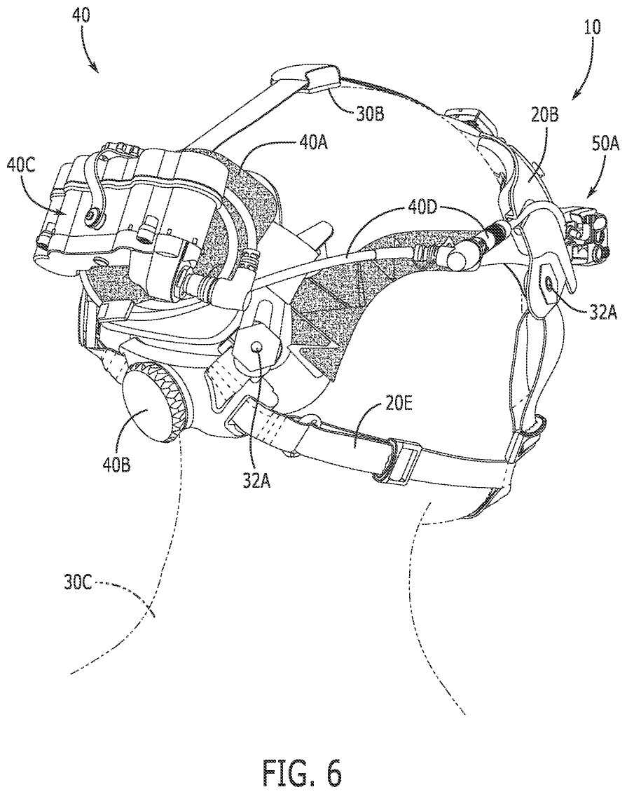

FIG. 6 depicts a perspective view of the detachable harness system 10 with a first accessory 40 in accordance with the present disclosure. Specifically, FIG. 6 depicts a battery pack 40C that may be removably attached at the back portion via the fastening mechanism 40A (e.g., hook and loop fastener). In addition, FIG. 6 depicts attachment of cables 40D to the flexible headband 20C via the hook and loop fastener disposed on the flexible headband 20C. In some aspects, the base plate 20B (and/or other components of the detachable harness system 10) may include engraved cut for the cables 40D.

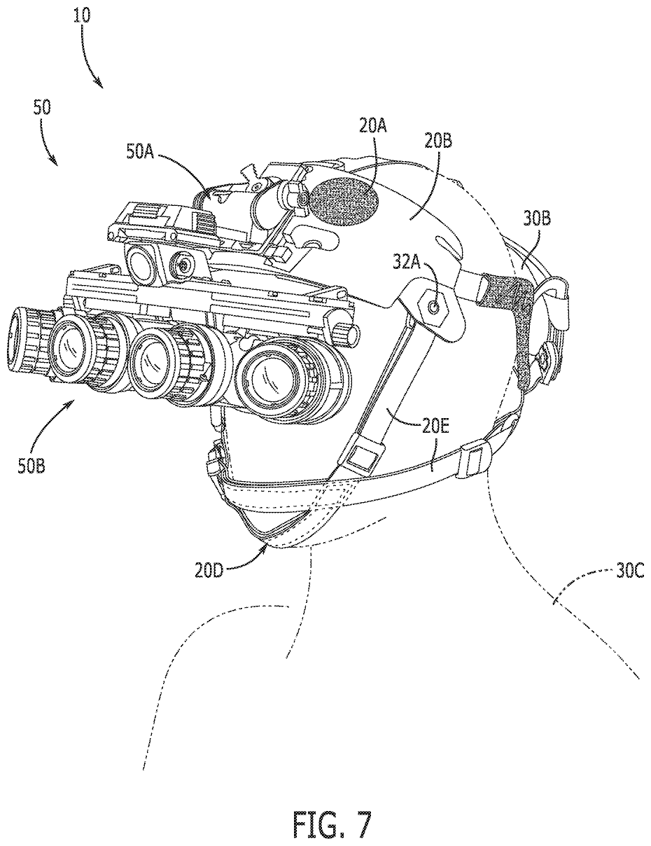

FIG. 7 depicts a perspective view of the detachable harness system 10 with a second accessory 50 in accordance with the present disclosure. Specifically, FIG. 7 depicts a night vision mount 50A and night vision goggles 50B that may be removably attached to the front portion of the detachable harness system 10, via attachment member mounted on the detachable harness system 10.

In some aspects, the detachable harness system 10 may be installed/placed/attached/screwed with the following methods including, but are not limited to a single method, any mixture of methods, or any combination thereof existing methods and future methods. Thus including, but not limited to any pre-treatment methods, process methods, and/or finishing methods. Furthermore, the following pre-treatment methods are not limited to; Boil-off (Laundering), Scouring, Desizing, Carbonizing, Singeing, Bleaching, and the use of Resins. Additionally, the following Finishing Methods are as follows but not limited to; Aesthetic Finishes/Coatings (Calendaring, Fragrance, Fulling, Mercerization, Napping, Sueding, Plisse, Shearing, Softening, Stiffening, Multiple Coating Layers, UV Inhibitors, Silicone, Urethane, Aluminized, Flame Retardant (FR), FR Urethane, Untrimmed, Trimmed, Wrinkle Resistant, PVC, DWR, PD, PU, 420D DWR, Opaque, 200D Nylon Oxford, Oxford, Nylon Packcloth, Marathon H100 Finish, H100 DWR, Urethane, Polyurethane, Textured Finishes, Functional Finishes, Chemical Finishes, Mechanical Finishes, Permanent Finishes, Durable Finishes, Semi-durable Finishes, Temporary Finishes, Stone Washing, Acid Washing, and Cellulose Washing. The process methods are not limited to; Laser Cutting, Slashing, Trimming, Hole Punching, Die Cutting, CNC, hot knife, heat cutting, hot cutting, soldering, plasma cutting, punching, 3-D printing, hand cutting/slicing, molding, molds, injection molding, water jetting, air jetting, welding, burning, sculpting, pressing, cropping, fusing, Direct Printing (Application Printing), Overprinting, Resist Printing, Wood Block Printing, Woodcutting, Wood Engraving, Chiaroscuro Woodcutting, Lino Cutting, Linoleum Cutting, Collagraphing, Collotype Printing, Movable Type Printing, Phototypesetting, Hand Block Printing, Perrotine Printing, Pigment Printing (Dry Printing), Transfer-printing, Heat-transfer Printing (Decal Transfer Printing), Discharge Printing, Sheet Printing, Digital Printing (Inkjeting and Xerography), Letterpressing, Letterpress Curved Offset Printing, Thermography, Planographic Printing, Lithographic Printing, Offset Printing, Offset Lithographic Printing, Lithography Curved Offset Printing, UV Lithography Printing, Laser Printing, Flexography (Flexo), Gravure Printing (Rotogravure), Gravure Printing Lamination, Silkscreen Printing, Dye-Sublimation Printing, Cliché-Verre Printing, Chine Colle Printing, Thermal Printing, Pad Printing, Calico Printing, Woolen Printing, Blotch Printing, Flock Printing, Flocking, Electrostatic Flocking, Mechanical Flocking, Warp Printing (Ikat Printing), Burn-out Printing, Duplex Printing, Engineered Printing, Machine Printing, Screen-Printing, Hand-screen Printing, Automatic-screen Printing, Rotary-Screen Printing, Bleaching, Stenciling (Pochoir), Engraving, Intaglio Printing (Etching, Soft-Ground Etching, Carborundum, Photogravure, Drypoint, Mezzotint, Aquatint), Biting, Engraved Roller Printing, Monotype Printing, Relief Printing, Procion Printing, Roll Printing, Cylinder Printing, Silk-Screen Printing, E Inks, Dyeing (Wet Prints), Conventional Dying (Aqueous Dying), Wet-on-Dry Dying, Wet-on-Wet Dying, Piece Dyeing, Jet Dyeing, Jig Dyeing, Beam Dyeing, Continuous Dyeing, Halftone Dyeing, Dyestuffs Dyeing, Reactive dyeing, Resist Dyeing, Batik Dyeing, Dip Dyeing, Solution Dyeing, Vat Dyeing, Immersion Dyeng, Dye Bathing, Stock Dying, Top Dying, Yarn Dying, Cross Dyeing, Union Dyeing, Tone-on-Tone Dyeing, Paddle-Dyeing, Rotary-Dyeing, Garment Dyeing (wearable or non-wearable garments), Coloring, Color Fastness, Painting, Spraying, Embroidery, and Stitching.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

The claimed invention is:

1. A detachable harness system, comprising:
a base plate; and
a first fastening member disposed at the base plate, the first fastening member being configured to engage with a second fastening member of a first accessory,
wherein the first fastening member comprises a female end of a fastener assembly, and wherein the second fastening member comprises a male end of the fastener assembly.

2. The detachable harness system of claim 1, wherein the base plate is disposed at a front portion of the detachable harness system.

3. The detachable harness system of claim 1, wherein the second fastening member comprises a screw, and the first fastening member comprises a cavity.

4. The detachable harness system of claim 1, wherein the first accessory comprises a helmet.

5. The detachable harness system of claim 1, wherein the base plate further comprises a hook and loop fastener at a front portion of the detachable harness system, and wherein the hook and loop fastener is configured to engage the detachable harness system with a second accessory.

6. The detachable harness system of claim 5, wherein the second accessory comprises a night vision system.

7. The detachable harness system of claim 5, wherein the hook and loop fastener is disposed at the base plate.

8. The detachable harness system of claim 1, further comprising a plurality of cushion pads disposed at a top portion of the detachable harness system.
